(19) United States
(12) Patent Application Publication
(10) Pub. No.: US 2004/0256886 A1
(43) Pub. Date: Dec. 23, 2004

(54) Shell structure for electrocar

(76) Inventor: Daniel P.H. Wu, Hsin-Feng Hsiang (TW)

Correspondence Address: CHARLES E. BAXLEY, ESQ., 90 JOHN STREET, THIRD FLOOR, NEW YORK, NY, 10038, US

(21) Appl. No.: 10/700,435

(22) Filed: Nov. 3, 2003

(30) Foreign Application Priority Data
Jun. 18, 2003 (TW) 092211173

(51) Int. Cl. B62D 31/00

(52) U.S. Cl. 296/181.1

(57) ABSTRACT

A shell structure for elecrtrocar includes an outer shell covering on an inner shell, both on the outer and the inner shells are provided with plural coupling members, the coupling members of the outer shell can be quick coupled to that of the inner shell, in this way, the outer shell can be quick assembled and dismantled from the inner shell, in addition, since the shell is designed as being easy dismantable, so as to provide more shells with different colors and style to the users and allow them to change the shells as desired by themselves, and thus the shell of the present invention has high marketing value.

### BACKGROUND OF THE INVENTION

1. Field of the Invention

The present invention relates to a shell structure for electrocar, and more particularly to a shell structure which can be quick assembled or dismantled from electrocar.

2. Description of the Prior Arts

A conventional shell 11 for electrocar 10 as shown in FIG. 1 is normally designed as being integrally formed, which can be mounted directly to frame of the electrocar 10 by virtue of plural screw bolts and screw nuts. Both for aesthetic's and safety's sake, the respective coupling portions between the shell and the frame of the electrocar are designed as being hidden or using special screw bolts (which should be screwed with special tools). In this case, it is inconvenient for the user cause the assembling and dismantling of the shell of conventional electrocar only can be done by professional worker, and the maintaining cost is accordingly high.

After long time of usage, the shell will be contaminated but it cannot be cleaned directly with water or detergents in order not to wet the inside of the electrocar, in this case, it is inconvenient for the user cause to carefully clean the shell with brush.

On the other hand, since the shell is difficult to be dismantled from the conventional electrocar, the color and style of the shell has been fixed and cannot be changed at the time the electrocar was purchased, it may be boring for the user cause the shell is not easy to be changed as desired.

The present invention has arisen to mitigate and/or obviate the afore-described disadvantages of the conventional shell for electrocar.

### SUMMARY OF THE INVENTION

The primary object of the present invention is to provide a shell structure for electrocar, which includes an outer shell covering on an inner shell, wherein both on the outer and the inner shells are provided with coupling members, with the coupling members, the outer shell can be quick assembled and dismantled from the inner shell.

The secondary object of the present invention is to provide a shell structure for electrocar, which is designed as being easy dismantable, so as to provide more shells with different colors and style to the users and allow them to change the shells as desired by themselves, thereby the shell of the present invention has high marketing value.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a perspective view of a conventional electric wheelchair;

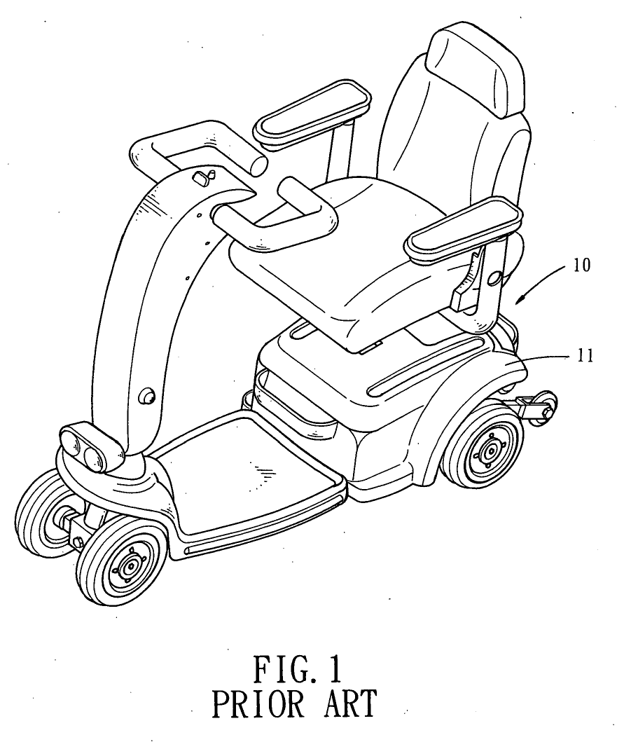

FIG. 2 is an exploded view of a shell structure for electrocar in accordance with the present invention;

FIG. 3 is a perspective assembly view of FIG. 2;

FIG. 4 is an exploded view of a shell structure for electrocar in accordance with a second embodiment of the present invention;

FIG. 5 is a perspective assembly view of FIG. 4;

FIG. 6 is an exploded view of a shell structure for electrocar in accordance with a third embodiment of the present invention;

FIG. 7 is an exploded view of a shell structure for electrocar in accordance with a fourth embodiment of the present invention;

FIG. 8 is a partial cross sectional view of FIG. 7.

### DETAILED DESCRIPTION OF THE PREFERRED EMBODIMENTS

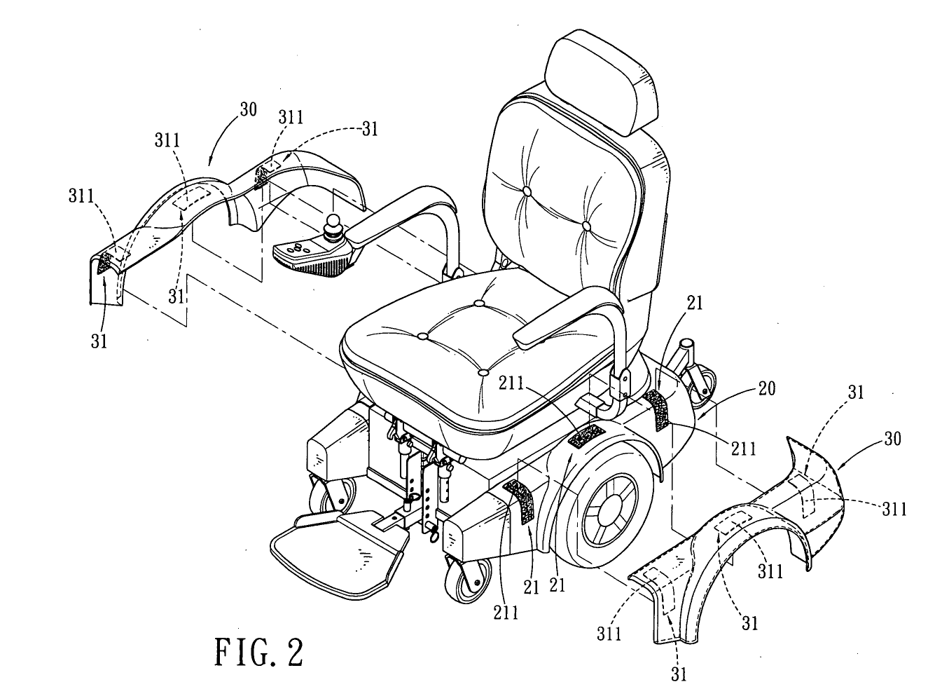

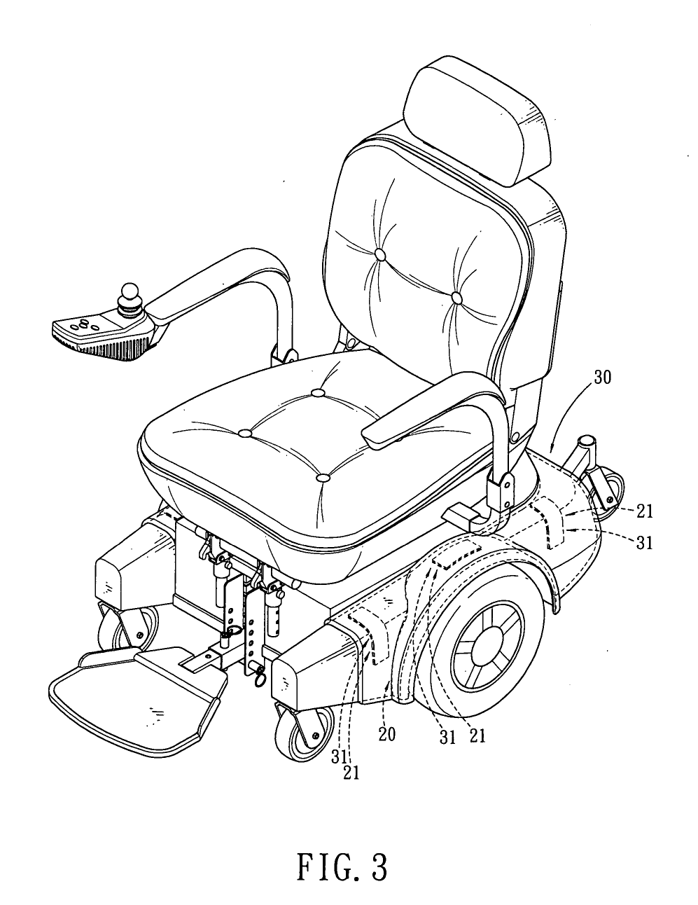

Referring to FIGS. 2-3, in which, a shell structure for electrocar in accordance with the present invention is shown and including an outer is shell 30 mounted on an inner shell 20.

The inner shell 20 is fixed to an electrocar for covering the inner of the electrocar, on the outer side of the inner shell 20 a plurality of coupling members 21 are disposed.

The outer shell 30 serves as a cover to be mounted on the inner shell 20, on the internal side of the outer shell 30 corresponding to the positions of the coupling members 21 on the inner shell 20 a plurality of coupling members 31 are disposed. In such a manner, the outer shell 30 is allowed to mount directly on the outer side of the inner shell 20. With these coupling members, the outer shell 30 can be quickly assembled or dismantled from the inner shell 20.

It will be noted that the above-mentioned coupling members 21, 31 of the bottom and the outer shells 20, 30 are designed to enable the outer shell 30 to be quick assembled or dismantled from the inner shell 20. In an embodiment, the connecting members 21, 31 can be magic tapes 211, 311 (as shown in FIGS. 2 and 3), which are provided to enable the outer shell 31 to be quick assembled or dismantled from the inner shell 20.

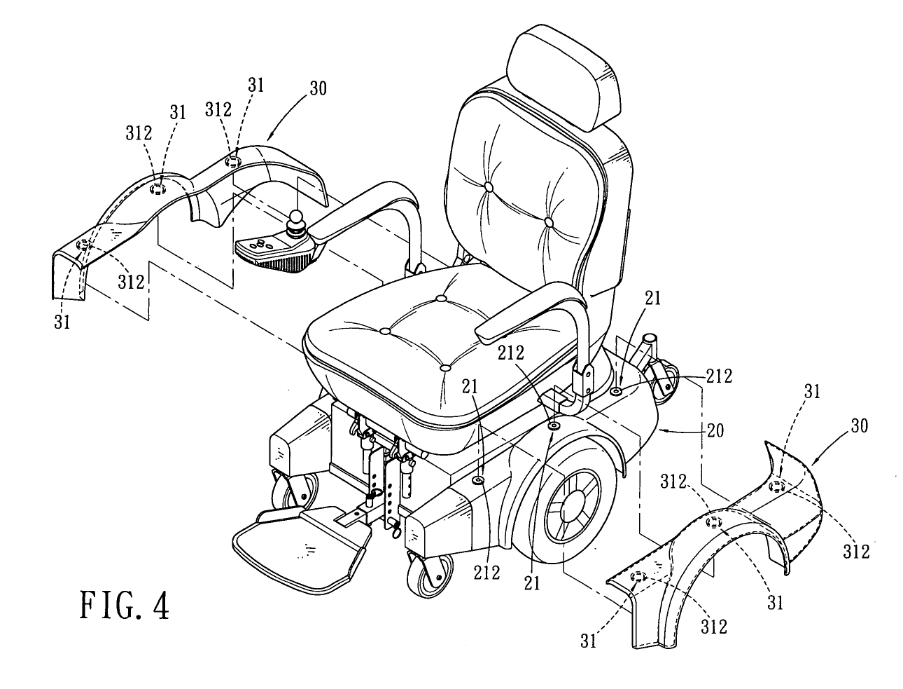

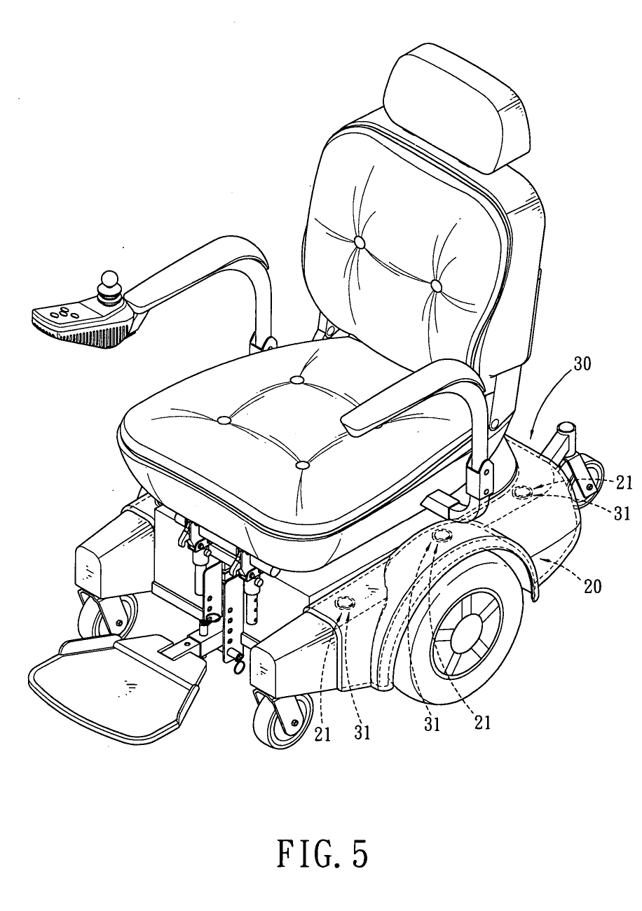

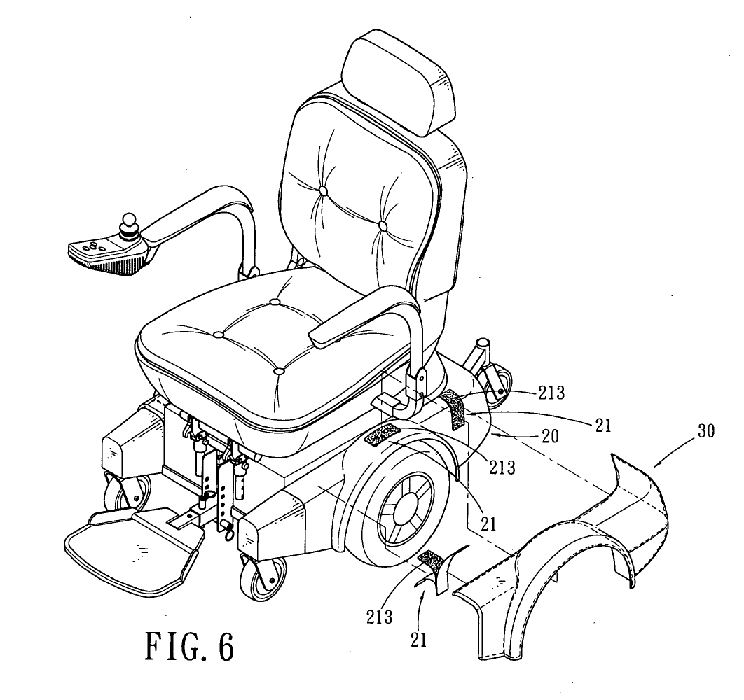

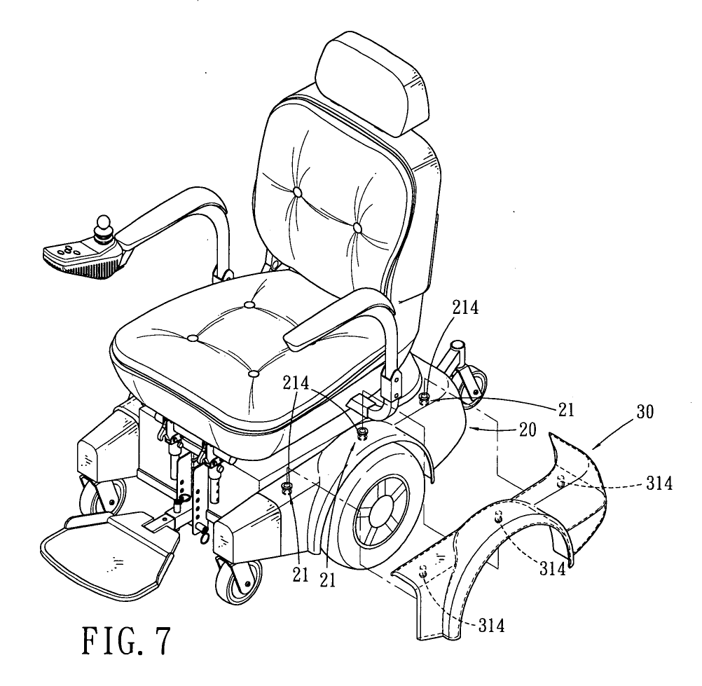

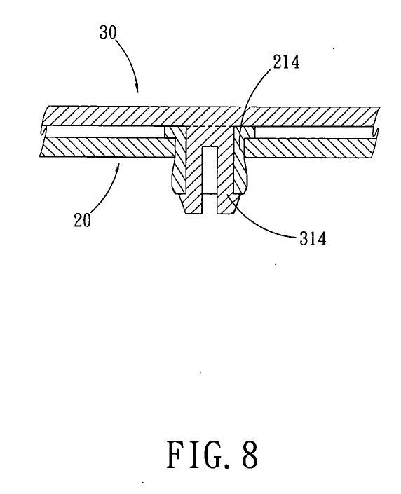

Referring further to FIGS. 4-5, wherein the coupling members 21, 31 also can be magnets 212, 312, which are provided to enable the outer shell 30 to be quickly assembled and dismantled from the inner shell 20. Besides the above-mentioned magnets and magic tapes, ordinary adhesive tape, double-sided adhesive tape 213 (as shown in FIG. 6) also can be provided to enable the outer shell 30 to be quickly assembled and dismantled from the inner shell 20. With reference to FIGS. 7 and 8, wherein on the internal side of the outer shell 30 are provided with plural engaging members 314, whereas on the outer side of the inner shell 20 is provided with plural receiving members 214 (which can be made of elastic plastic), each receiving member is defined with a hole, the engaging members 34 are provided to engage in the respective holes of the receiving members 214, so as to enable the outer shell 30 to be quickly assembled and dismantled from the inner shell 20.

It can be concluded that the design of the shell for electrocar of the present invention is distinguishable over that of the prior arts, with the design, the following functions of the present invention can be obtained:

First, after long time of usage, the outer shell 30 is susceptible to dirt and contamination, the user is able to dismantle it from the electrocar and clean it directly, after the outer shell 30 has been cleaned, it can be quick assembled to the electrocar, so as to prevent the electrocar from being contaminated by the detergent.

Second, since the design of the present invention enables the users to quick change the shell of electrocar by themselves, in this case, the design of the present invention has high marketing value.

Third, in case that the shell is damaged, the user can replace it by themselves, such that the maintenance cost can be substantially reduced.

While we have shown and described various embodiments in accordance with the present invention, it should be clear to those skilled in the art that further embodiments may be made without departing from the scope of the present invention.

What is claimed is:

1. A shell structure for electrocar, which comprising an outer shell mounted on a inner shell, wherein the inner shell firmly fixed to an electrocar, serving as a screen to hide inside of the electrocar;
on the outer side of the inner shell a plurality of coupling members disposed, the outer shell covering on the inner shell, on the internal side of the outer shell corresponding to the positions of the coupling members on the inner shell a plurality of coupling members disposed, with these coupling members, the outer shell can be quickly assembled or dismantled from the inner shell.

2. The shell structure for electrocar as claimed in claim 1, wherein the respective coupling members on the outer and the inner shell can be in form of magic tapes, with the magic tapes, the outer shell can be quickly assembled or dismantled from the inner shell.

3. The shell structure for electrocar as claimed in claim 1, wherein the respective coupling members on the outer and the inner shell can be in form of magnets, with which, the outer shell can be quickly assembled or dismantled from the inner shell.

4. The shell structure for electrocar as claimed in claim 1, wherein the respective coupling members on the outer and the inner shell can be in form of double-sided adhesive tape, with which, the outer shell can be quickly assembled or dismantled from the inner shell.

5. The shell structure for electrocar as claimed in claim 1, wherein on the outer shell of the electrocar can be provided with engaging members, whereas on the inner shell provided with receiving members, the engaging members can be quick engaged in holes of the respective receiving members, whereby to allow the outer shell to be quickly assembled or dismantled from the inner shell.
